(19) United States
(12) Patent Application Publication
(10) Pub. No.: US 2009/0228397 A1
(43) Pub. Date: Sep. 10, 2009

(54) EXCHANGE FOR TAGGED USER INFORMATION WITH SCARCITY CONTROL

(75) Inventors: Omar Tawakol, Bellevue, WA (US); Grant Ries, Seattle, WA (US); Michael Bigby, San Jose, CA (US); Alexander Hooshmand, San Francisco, CA (US)

Correspondence Address: DARBY & DARBY P.C., P.O. BOX 770, Church Street Station, New York, NY, 10008-0770, US

(73) Assignee: Blue Kai, lnc., Bellevue, WA (US)

(21) Appl. No.: 12/399,796

(22) Filed: Mar. 6, 2009

Related U.S. Application Data
(60) Provisional application No. 61/068,535, filed on Mar. 7, 2008.

(51) Int. Cl. G06Q 30/00

(52) U.S. Cl. 705/80; 705/26

(57) ABSTRACT

Embodiments of the invention are directed to managing an exchange of user profile data through an auction that controls distribution to one or more top bidders. Visiting users of a data seller's website are tagged based on the visiting user's interactions with the data seller's website. The data seller or a network provider may tag the visiting users. The data sellers submit user data and user profile identifiers to an exchange service. Data buyers submit corresponding categories of user data for a campaign, and submit bids for profile data or user data of each user. A bid is generally specified for a specific user, where the bid may be per user, per category. The exchange service associates user data provided by a data seller with categories of data requested by a data buyer, and ranks bids. The highest bidder may receive access to user data for a predefined period.

### CROSS-REFERENCE TO RELATED APPLICATIONS

This application is a utility patent application based on a previously filed U.S. Provisional Patent Application, Ser. No. 61/068,535 filed on Mar. 7, 2008, the benefits of which are hereby claimed under 35 U.S.C. §119(e) and which is incorporated herein by reference.

### FIELD OF ART

The present invention is directed to managing the exchange of information, and more particularly, to brokering information about users through an auction that controls distribution of the information to a top set of bidders.

### BACKGROUND

Data is often a hidden and fragmented entity on the web. Even the largest web publishers that have robust profiles of their user's behavior on their site, often fail to capture the context of user's behavior across the web. Publishers and advertisers have historically been discouraged from sharing their data because of issues such as a lack of a marketplace-driven, dollar amount to their data, difficulty in buying and selling data, and sensitivity to consumer's privacy concerns. It is with respect to these considerations and others that the present invention is directed.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description Of The Embodiments, which is to be read in association with the accompanying drawings, wherein:

FIG. 1 illustrates a diagram of one embodiment of an exemplary environment in which the invention may be practiced;

FIG. 2 shows a schematic diagram of one embodiment of an exemplary client device;

FIG. 3 illustrates a schematic diagram of one embodiment of an exemplary network device;

FIG. 4 illustrates a flow chart of an example overall exchange process;

FIG. 5 illustrates a flow chart of an example embodiment of an optimization process for an exchange service;

FIG. 6 illustrates a chart of an example embodiment of a data seller workflow process for an exchange service;

FIG. 7 illustrates a taxonomy mapping workflow of an example embodiment;

FIG. 8 illustrates a data collection process of an example embodiment;

FIG. 9 illustrates a chart of an example embodiment of a data buyer workflow process for an exchange service;

FIG. 10 illustrates a flow chart of an example embodiment of a user segment process for an exchange service;

FIG. 11 illustrates a flow chart of an example embodiment of a user segment process for an exchange service; and

FIG. 12 illustrates a flow chart of an example embodiment of a user segment certification process for an exchange service.

### DETAILED DESCRIPTION OF EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise:

BidTable—A table that is uploaded to servers and holds bid information used for an auction. Variables in the table may include CampaignID, MaxBid and TaxID.

PreviousWinningBid—A bid that has won a previous auction and been recorded in a cookie as a winning bid in a WinnerSlot.

WinnerSlot—Is a slot for recording winning in the cookie. At any point in time there may be a limited number of WinnerSlots available as predefined by product management.

MaxAllowedTimeWindow—A maximum amount of time a PreviousWinningBid is allowed to occupy a WinnerSlot. This may be defined by product management and may be changeable.

MaxNewWinners—When a user hits a biddable tag, an auction is conducted. There can be multiple winners of this auction. MaxNewWinners determines the maximum number of winners in an auction.

PotentialWinners—These are the highest bids in a BidTable corresponding to TaxIDs or a combination of TaxIDs that a user has. The number of PotentialWinners is generally determined by the lower of MaxNewWinners or the total number of bids in the BidTable.

CountPotentialWinners—Number of potential winners determined from BidTable.

TotalWinnerSlots—This is the maximum number of WinnerSlots allowed and is generally determined by product management.

CountPreviousWinningBids—This is a number of PreviousWinningBids remaining in a cookie after outdated bids are purged from the cookie.

AvailableWinnerSlots—This is equal to TotalWinnerSlots—CountPreviousWinningBids

NewWinningBids—PotentialWinners that win an auction and can be written to an AvailableWinnerSlot.

Category—A subject or a topic of user data. For example, user data for a particular user who purchased an SUV may be associated with a category of “SUV consumer.” The exchange service itself may associate raw user data with one or more categories. In addition, association of raw user data with one or more categories may also be by a data seller, a data buyer, a customer of a data buyer, or some other user of the exchange service. Association of raw user data with a category may also be referred to as tagging the raw user data, and user data that has been associated with a category may also be referred to as tagged user data or tagged data.

Subcategory—A subset of a category. For example, user data associated with a category of “SUV consumer” may be also be associated with a subcategory of “SUV”.

Supercategory—A superset of one or more categories. For example, user data associated with a category of “SUV consumer” may also be associated with such supercategories as “automobile consumer” or “automobile”. One or more categories and/or subcategories may be aggregated into supercategories by the exchange service, by a data seller/data provider, data buyer, or other user of the exchange service. Because any category may also be considered to be a subcategory and/or supercategory depending on its position within some hierarchy of categories/subcategories/supercategories, the term category as used herein may refer generally to a category and/or a subcategory and/or a supercategory.

User data—A piece of information associated with a user. User data may be a word, a phrase, a name, a numeral, a date/time, a symbol, any other indicator, or any combination of same. User data may function as a user identifier, a user name, a user attribute, an indicator of a user's behavior, purchase or action, or any other indicator that a data seller may associate with a user, or any combination of these. User data may be associated with a user who visits a data seller's web site, who visits a data seller's physical place of business, who purchases or uses a data seller's products or services, who expresses an interest (either explicitly or implicitly through behavior) in a data seller's products or services, or who is otherwise tracked by the data seller by any means and for any purpose. An element of user data may also be referred to as a tag. Raw user data may be user data that has not yet been associated with one or more categories, subcategories, and/or supercategories.

User data type—A type of user data, such as a search type, browse type, demographic type, purchase type, or any other type of user data. For example, a search type may include user data about a time, place, manner or frequency of a user's search for certain information on a data seller's website. In at least some embodiments, a user data type may also be a category, sub-category, or super-category.

Segment—A grouping or collection of one or more categories or sub-categories. A data seller, data buyer, customer of a data buyer, or other user of the exchange, or the exchange itself, may indicate a combination of categories, sub-categories with boolean operations such as AND, OR, XOR, or NOT to make a segment. A segment may include categories/sub-categories which include tags of the same type or of different types. User data from one or more segments may be selected or otherwise requested by a data buyer who bids on user data.

Recency window—A time period. A recency generally indicates a time period to filter cookies that are outside a desired timestamp.

Flight date—A start or stop date for one or more segments. Segments of tags can also be paused and resumed. An advertising campaign (usually run by a buyer) can be started, paused, and stopped according to a span of flight dates.

Briefly stated, the invention is directed to managing an exchange of information about users through an auction that controls distribution of the information to one or more top bidders.

### Illustrative Operating Environment

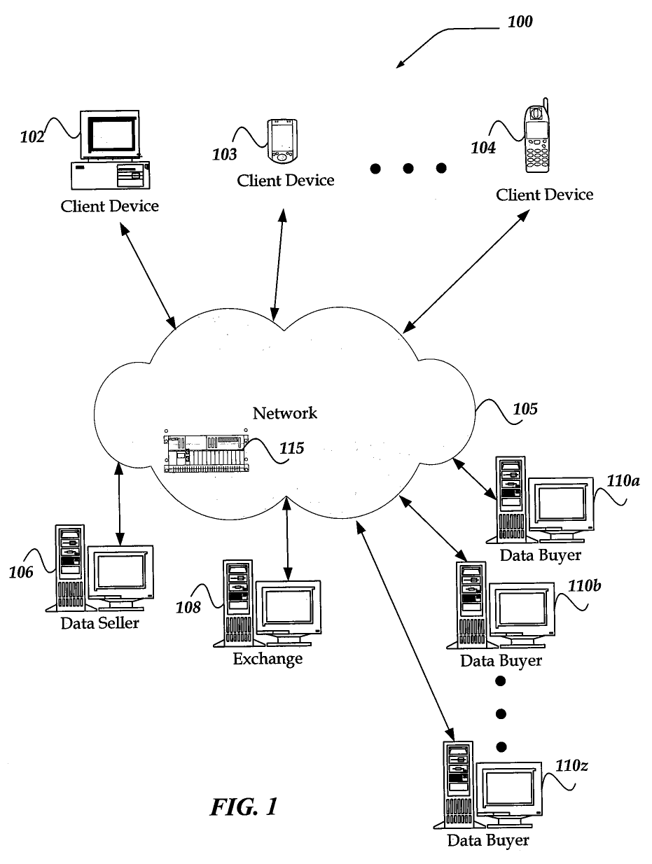

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes client devices 102-104, network 105, one or more seller device(s) 106, a data exchange device 108, and multiple buyer devices 110a-110z. Network 105 is in communication with and enables communication between each of client devices 102-104, seller device 106, data exchange device 108, and buyer devices 110a-110z.

Client devices 102-104 may include virtually any computing device capable of receiving and sending a message over a network, such as network 105, to and from another computing device, such as seller device 106, exchange device 108, buyer devices 110a-110z, each other, and the like. The set of such devices may include devices that typically connect using a wired communications medium such as personal computers, multiprocessor systems, microprocessor-based or programmable consumer electronics, network PCs, and the like. Similarly, client devices 102-104 may be any device that is capable of connecting using a wired or wireless communication medium such as a personal digital assistant (PDA), pocket PC, wearable computer, and any other device that is equipped to communicate over a wired and/or wireless communication medium. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like.

Each client device within client devices 102-104 may include a browser application that is configured to send, receive, and display web pages, and the like. The browser application may be configured to receive and display graphics, text, multimedia, and the like, employing virtually any web based language, including, but not limited to Standard Generalized Markup Language (SMGL), such as HyperText Markup Language (HTML), extensible markup language (XML), a Handheld Device Markup Language (HDML), such as Wireless Markup Language (WML), WMLScript, JavaScript, and the like. Client devices 102-104 may further include a messaging application configured to send and/or receive a message to/from another computing device employing another mechanism, including, but not limited to instant messaging (IM), email, Short Message Service (SMS), Multimedia Message Service (MMS), internet relay chat (IRC), mIRC, Jabber, and the like.

Network 105 is configured to couple one computing device to another computing device to enable them to communicate. Network 105 is enabled to employ any form of computer readable media for communicating information from one electronic device to another. Also, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, fall or fractional dedicated digital lines including T1, T2, T3, and T4, Digital Signal level 3 (DS3), Optical Carrier 3 (OC3), OC12, OC48, Asynchronous Transfer Mode (ATM), Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 105 is constructed for use with various communication protocols and technologies, including transmission control protocol/internet protocol (TCP/IP), user datagram protocol (UDP), a wireless application protocol (WAP), global system for mobile communications (GSM), code division multiple access (CDMA), time division multiple access (TDMA), general packet radio service (GPRS), ultra wide band (UWB), IEEE 802.16 Worldwide Interoperability for Microwave Access (WiMax), and the like. In essence, network 105 includes any communication method by which information may travel between client devices 102-104, seller device 106, exchange device 108, and/or buyer devices 110a-110z. Network 105 may include one or more network management devices 115, which may include network providers, load balancers, application managers, or the like. Network management devices 115 may manage communication sessions, tag communication traffic, place data cookies on client devices, and perform other network management operations.

The media used to transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data. Such data can be communicated through communication media in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wireless media such as fluids or space for acoustic, RF, infrared, and other wireless signals, and wired media such as twisted pair, coaxial cable, fiber optics, wave guides, and other wired media.

Seller device 106, exchange device 108, and buyer devices 110a-110z may comprise multiple computing devices, components of a single computing device, or a single device with multiple software features. Seller device 106 may provide content such as web sites, online journals (e.g., blogs), photos, reviews, online services such as messaging, search, news, shopping, advertising, travel services, or the like. While providing such content or services, seller device 106 may gather information about client users, such as products viewed, articles read, or the like. The gathered information may be used to determine behaviors, create profiles, or enhance the user information. Exchange device 108 may organize or reorganize the user data from one or more sellers, and may enable a seller to auction, or otherwise provide, the user information to one or more buyers. Buyer devices 110a-110z generally enable buyers to review, bid on, or otherwise access the user information.

Any one of these devices may be a server and/or client, but to simplify the discussion of example embodiments, they are generally referred to herein as servers. Briefly, each server may comprise any computing device capable of connecting to network 105 and may manage content or provide services for a network user, such as a user of at least one of client devices 102-104. Devices that may operate as a server include dedicated servers, personal computers, desktop computers, multiprocessor systems, microprocessor-based or programmable consumer electronics, network PCs, and the like.

### Illustrative Client Device

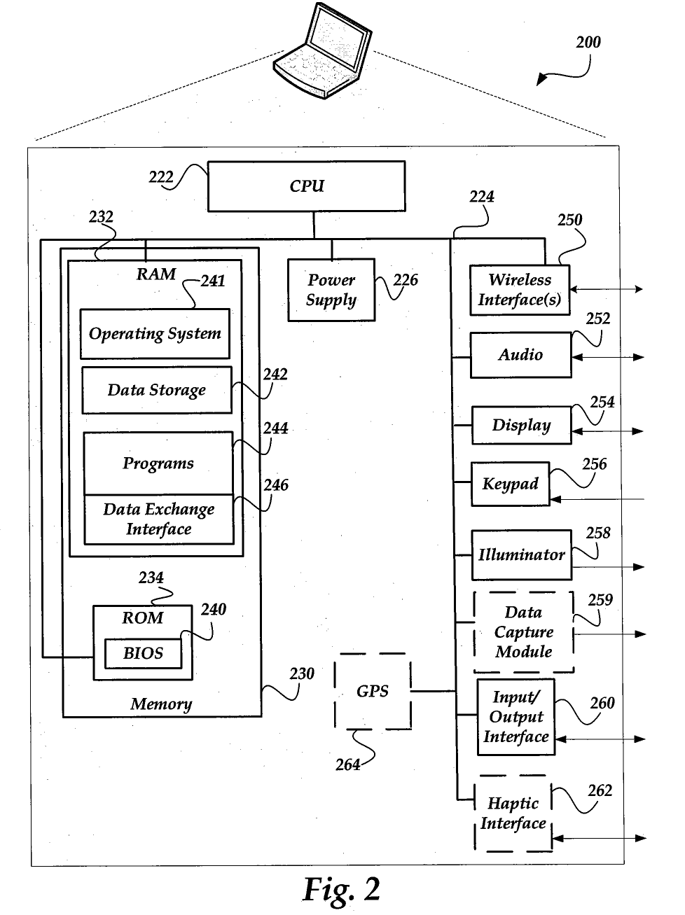

FIG. 2 shows an example client device 200, according to one embodiment of the invention for use as a reference data collector device. In one embodiment, client device 200 is a mobile device, such as a laptop computer. Another example of a mobile device includes a PDA or a cellular telephone that is arranged to send and receive voice communications and messages such as SMS messages via one or more wireless communication interfaces. Oftentimes, mobile electronic devices will be capable of personal communication by connecting to one or more wireless networks, connecting to multiple nodes of a single wireless network, communicating over one or more channels to one or more networks, or otherwise engaging in one or more communication sessions. Generally, client device 200 may comprise any mobile or stationary electronic device. Such devices include personal computers, laptops, palmtops, PDAs, handheld computers, cellular telephones, smart phones, pagers, radio frequency (RF) devices, infrared (IR) devices, integrated devices combining one or more of the preceding devices, and the like. Client device 200 may also comprise other electronic devices such as multiprocessor systems, microprocessor-based or programmable consumer electronics, network PCs, wearable computers, and the like.

Client device 200 may include many more, or fewer, components than those shown in FIG. 2. However, the components shown are sufficient to disclose an illustrative embodiment for practicing the present invention. As shown in the figure, client device 200 includes a processing unit 222 in communication with a mass memory 230 via a bus 224.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of Windows®, UNIX, or LINUX®, or a specialized mobile communication operating system such as Windows Mobile™, the Symbian® operating system, or the like. The operating system may include, or interface with a Java® virtual machine module that enables control of hardware components and/or operating system operations via Java application programs.

Memory 230 further includes one or more data storage units 242, which can be utilized by client device 200 to store, among other things, programs 244 and/or other data. Programs 244 may include computer executable instructions which, when executed by client device 200, transmit, receive, render, and/or otherwise process markup pages such as HTML pages, XML pages, WAP pages (sometimes referred to as WAP cards), and the like. Accordingly, programs 244 may include a browser program of computer executable instructions, which may be run under control of operating system 241 to enable and manage requesting, receiving, and rendering markup pages and messages (e.g., HTTP, TCP/IP, SMS, MMS, IM, email, and/or other messages), audio, video, and enable telecommunication with another user of another client device. Other examples of application programs include messaging applications, calendars, contact managers, task managers, transcoders, database programs, word processing programs, spreadsheet programs, games, and so forth.

In addition, mass memory 230 of some clients may include a data exchange interface 246, which may be run within a browser, within a web page, as an external module under control of operating system 241, or via another configuration. Data exchange interface 246 enables a user to communicate with, submit user data, buy user data, manage accounts, or perform other operations available through the data exchange device.

Client device 200 also includes a power supply 226, one or more wireless interfaces 250, an audio interface 252, a display 254, a keypad 256, an illuminator 258, an optional data capture module 259, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station, or directly with another client device. Wireless interface 250 includes circuitry for coupling client device 200 to one or more wireless networks, and is constructed for use with one or more communication protocols and technologies including, but not limited to, TCP/IP, UDP, GSM, CDMA, TDMA, SMS, GPRS, WAP, UWB, IEEE 802.16 (WiMax), and the like.

Audio interface 252 is arranged to produce and/or receive audio signals such as the sound of a human voice, music, and the like. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a client device. Display 254 may also include a touch sensitive screen arranged to receive input from an object such as a stylus or a digit from a human hand.

Keypad 256 may comprise any input device arranged to receive input from a user. For example, keypad 256 may include a keyboard, a push button numeric dial, or the like. Keypad 256 may also include command buttons that are associated with selecting and performing changeable processes. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the mobile device to illuminate in response to actions. Illuminator 258 may further be used as a flash for image capture. An optional data capture module 259, such as a camera, may be included in client device 200. If the data capture module is included, the client device may obtain images, video, temperature, pressure, or other data.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, and the like. Optional haptic interface 262 is arranged to provide tactile feedback to a user of the client device. For example, the haptic interface may be employed to vibrate client device 200 in a particular way when another user of a client device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), Enhanced Observed Time Difference (E-OTD), cell identifier (CI), service area identifier (SAI), enhanced timing advance (ETA), base station subsystem (BSS), or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances.

### Illustrative Network Device

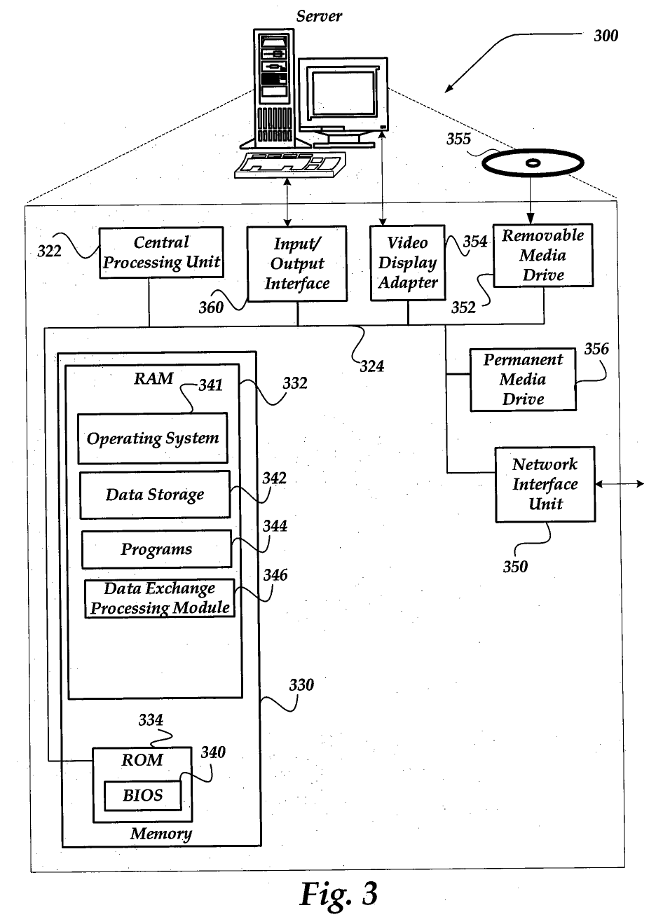

FIG. 3 shows one embodiment of a network device, according to one embodiment of the invention. Network device 300 may include many more, or fewer, components than those shown. The components shown, however, are sufficient to disclose an illustrative embodiment for practicing the invention. Network device 300 may represent, for example, seller device 106, data exchange device 108, buyer devices 110a-110z, or another client device of FIG. 1. For example purposes, network device 300 will be described as a server device.

As shown in the figure, server device 300 includes a processing unit 322 in communication with a mass memory 330 via a bus 324. Mass memory 330 generally includes a RAM 332, a ROM 334, and other storage means. Mass memory 330 illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EEPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 330 stores a basic input/output system (“BIOS”) 340 for controlling low-level operation of server device 300. The mass memory also stores an operating system 341 for controlling the operation of server device 300. It will be appreciated that this component may include a general purpose operating system such as a version of Windows, UNIX, LINUX, Solaris, or the like. The operating system may also include, or interface with a Java virtual machine module that enables control of hardware components and/or operating system operations via Java application programs.

Mass memory 330 further includes one or more data storage units 342, which can be utilized by server device 300 to store, among other things, programs 344 and/or other data. Programs 344 may include computer executable instructions which can be executed by server device 300 to implement a markup handler application, such as an HTTP handler application for transmitting, receiving, and otherwise processing HTTP communications, a WAP handler application for transmitting, receiving, and otherwise processing WAP communications, and the like. Similarly, programs 344 can include a secure socket layer (SSL) handler application for handling secure connections, such as initiating communication with an external application in a secure fashion. Other examples of application programs include content management applications, messaging applications, schedulers, calendars, web services, transcoders, database programs, word processing programs, spreadsheet programs, and so forth. Accordingly, programs 344 can process images, audio, video, or markup pages, enable telecommunication with another user of another electronic device, and/or other services.

In addition, mass memory 330 may store a data exchange processor 346. Data exchange processor 346 may include computer executable instructions, which may be run under control of operating system 341 to receive, organize, sell, or otherwise manage the exchange of user data. In one embodiment, data exchange processor 346 generally communicates data sellers and buyers to operate an auction of client user data.

Server device 300 also includes an input/output interface 360 for communicating with input/output devices such as a keyboard, mouse, wheel, joy stick, rocker switches, keypad, printer, scanner, and/or other input devices not specifically shown in FIG. 3. A user of server device 300 can use input/output devices to interact with a user interface that may be separate or integrated with operating system 341, programs 344, and/or other modules. Interaction with the user interface includes visual interaction via a display, and a video display adapter 354.

Server device 300 may include a removable media drive 352 and/or a permanent media drive 354 for computer-readable storage media. Removable media drive 352 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 355, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 350, server device 300 can communicate with a wide area network such as the Internet, a local area network, a wired telephone network, a cellular telephone network, or some other communications network, such as network 105 in FIG. 1. Network communication interface unit 350 is sometimes known as a transceiver, transceiving device, network interface card (NIC), and the like.

### Illustrative Logic Operations

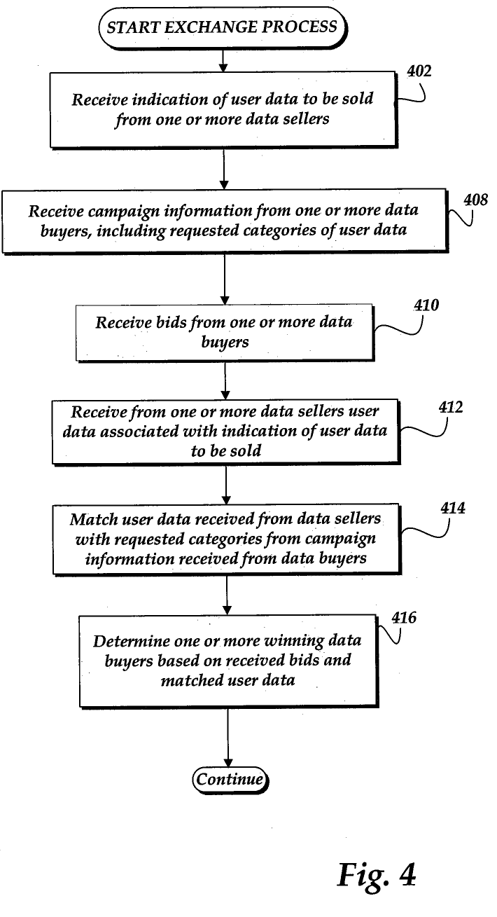

FIG. 4 illustrates a flow chart of an example embodiment of an exchange process. At an operation 402, the exchange process may receive an indication from one or more data sellers of raw user data that may be sold to data buyers through the exchange process. To provide such an indication, a data seller may use a browser interface, a client application program, or other interface to register with an exchange service and input particular information about the raw user data offered for sale. The raw user data itself may include keywords, phrases, or other indicators that the data seller may associate with users who visit the data seller's web site, who use the data seller's products or services, or whose behavior is otherwise tracked by the data seller. For example, a data seller may operate an automobile dealer website and gather information about the behavior of each user that visits the website. Also, the data seller may generate additional raw data regarding the visiting user's interactions with the website. For instance, the data seller may provide a tag of “SUV consumer” to the raw data associated with a user who reviews information about sport utility vehicles (SUVs) on a website. Additionally, when inputting raw user data to the exchange service, the data seller may provide and associate one or more topical categories and/or one or more subcategories and/or one or more supercategories for the raw data that corresponds to one or more users. For example, consistent with the raw user data, the data seller may select a topical category of “automobiles,” and select sub-categories of “SUV Consumer” and “SUVs.” In at least some embodiments, the exchange service itself may associate one or more categories and/or subcategories and/or supercategories with the raw user data. Through this association, the exchange service may normalize the categories, sub-categories, and supercategories of raw user data provided by different data sellers.

The data seller or the exchange service may also associate the inputted raw user data with one or more user data types. User data types may describe a kind of user data, such as a search type, a browse type, a demographic type, a purchase type, or the like. As one example, a search type of raw user data may indicate raw user data describing when, or how often, a website visitor performed a search for certain information on the data seller's website. For instance, the data seller may specify “SUV consumer searched” as a search type of user data that includes information on the frequency at which a website visitor used a search feature on the data seller's website to search for SUV automobiles. Similarly, the data seller may specify “SUV consumer purchased” as a purchase type of user data that includes information on the date on which a website visitor purchased parts for an SUV through the data seller's website.

In addition, the data seller may maintain a profile of user data for each visiting user of the data seller's website. The profile may also include tags for offline information, gathered during interactions between the data seller and a user/customer other than a user's visit to the data seller's website. For example, some visiting users of the website may be registered users who are also consumers or customers at the data seller's physical store. A consumer who purchased an SUV at the data seller's dealership may register with an email address, user ID, etc. for subsequent access to service information or the like. The offline purchase may be included as user data in the consumer's profile along with online user data. Those skilled in the art will recognize that many variations of profiles, user data, tags, tag types, categories, subcategories, supercategories or other information may be configured and provided to an exchange service.

Though not depicted in FIG. 4, at operation 402, in at least some embodiments the exchange service may also receive from the data seller a list of potential data buyers that should not be allowed to purchase, acquire or otherwise receive the data seller's user data. For example, an automobile dealership may wish to prevent the sale of its user data to competing automobile dealerships.

The data seller may choose one or more methods to provide raw user data or user data associated with one or more categories/subcategories/supercategories to the exchange service. The data seller may submit user data at a number of possible times, such as one time, on a monthly basis, on an hourly basis, or the like. Alternatively, user data may be fed automatically from the data seller to the exchange service, using a script or other module, at the moment a user visits the seller's website. In an example embodiment, the exchange service provides the data seller with a universal script tag. The data seller places the universal script tag within a global site header or footer of the data sellers website. The universal script tag will generally cause a cookie to be placed on the client devices of visitors to the data seller's website. The cookie may be a separate cookie that is intended for use by the exchange service, may be a portion of a data seller cookie, or other configuration. Each cookie may store the corresponding user's profile of user data collected by the data seller, when the user interacts with the data seller's website. The cookie may also include a user identifier that can be used by the exchange service to identify the visiting user to a winning data buyer. In addition, or alternatively, the data seller may store the user profiles in a database. At predefined times, and/or whenever a user visits the data seller's website, the profile of user data (or changes to the profile of user data) may be sent to the exchange service. In this embodiment, the data seller may provide user data in near real time as a user interacts with the data seller's website.

In another embodiment, the universal script tag may be provided to a network provider, such as an internet service provider, an application delivery provider, a network load balancing service, or the like. The network provider generally provides network services for visitor traffic that interacts with the data seller's website. Thus, the network provider may manage the cookies and/or other user tracking. The network provider may send the user data to the data seller for delivery to the exchange service. In addition, or alternatively, the network provider may deliver the user data directly to the exchange service on behalf of the data seller.

In another embodiment, a universal script, or an alternate script, may be provided to data buyers. When client users visit a data buyer website, the script may place a cookie on the client device and request from the exchange service user data from data sellers regarding the visiting user. The cookie may also include a user identifier, browser session identifier, client device identifier, or other identifier. The identifier may subsequently be passed to the exchange service to determine if user data from one or more data seller's is available regarding this visiting user. This may enable a data buyer to bid on additional user data associated with this visiting user, based on the data buyer's desired user data. The additional information may enable the data buyer to present more relevant content, services, advertisements, or other information to the visiting user. The relevant information may be provided while the user is still visiting the data buyer's web site, and/or upon a return visit.

The exchange service may also provide a browser interface, a client application program, or other interface for data buyers to register with the exchange service and bid for user data. At an operation 408, the exchange service receives information from a data buyer to configure one or more campaigns that would utilize user data from data sellers. A campaign may be a brand-awareness campaign, a sale advertising campaign, a voting campaign, or other effort to provide information to targeted users that would find the information relevant. A campaign may be specified by one or more requested user data categories, subcategories and/or supercategories that the data buyer may seek to purchase and utilize. A campaign may also be divided into segments, each of which specifies one or more categories/subcategories/supercategories. A data buyer may input or select categories/subcategories/supercategories that are relevant to the data buyer's campaign. The data buyer may also select categories/subcategories/supercategories that were previously specified by one or more data sellers. In addition, or alternatively, the data buyer may input data buyer categories that may or may not match data seller's categories or the exchange service-created categories. The exchange service can use synonyms, demographic information, or other information to determine data seller categories that may be associated with data buyer categories.

The data buyer may also submit a maximum bid, which the data buyer is willing to make for user data that matches the data buyer's requested categories of user data. In one embodiment, the maximum bid corresponds to a bid amount per user, per category/subcategory/supercategory. In this case, the data buyer is willing to pay a specified maximum bid amount for each user that matches a buyer-specified category of user data. The data buyer may specify a maximum bid amount for each particular category/subcategory/supercategory of requested user data. The data buyer may also optionally specify a budget cap, indicating a maximum total amount that the data buyer is willing to spend on user information.

In another embodiment, the data buyer may specify a maximum bid amount for the buyer-specified group of categories/subcategories/supercategories for a segment of the buyer's campaign, or the buyer's entire campaign. In still other embodiments, the maximum bid may be customized for other criteria. For example, the maximum bid may correspond to a maximum amount that the data buyer is willing to pay for a predefined number of users that match a buyer-specified category (e.g., max bid per 100 users). In some embodiments, a category may be associated with varying values, such as location. The data buyer may specify a location, and a scale of bids that correspond to a distance from the buyer-specified location. This may be used for bidding on real-time user information of mobile users. Other categories associated with variable values may include frequency of visiting a website, a time since a last visit to the website, or the like.

Conversely, the data buyer may also specify a recency period of time, outside of which the data buyer may consider user data too old and no longer worth purchasing. For example, the data buyer may specify that bids will only be made for user data that was gathered, or associated with a category, within the last week. User data gathered or associated with a category longer than a week ago may then be filtered out, and would not be bid on by that data buyer. The recency period may be any other time period, including a month, a day, an hour, a minute, or the like. Similarly, the data buyer may specify a bidding time span during which the data buyer is willing to bid on user data with the buyer-specified categories. The bidding time span may be a date range, a time of day, certain days of the week, or other time span. The bidding time span may be specified as a recurring period, such as each weekend.

After completing data buyer configurations, the exchange service receives bids from data buyers, at an operation 410. A bid may be received (or generated from a standing order) as a result of a user visiting a data seller website, triggering the universal script tag on the seller website to set (or check) a cookie on the visiting user's client, and to pass the cookie information (e.g., a user identifier and/or user data) to the exchange service. This may trigger the start of an auction among currently active data buyers. Alternatively, receiving cookie information may simply cause the exchange service to store the information, and await a request from a data buyer.

Further, a bid may be received as a result of a user visiting a data buyer website, triggering the universal script on the buyer website to set (or check) a cookie on the visiting user's client, and to pass the cookie information (e.g., a user identifier and/or user data) to the exchange service to determine whether other information is available from data sellers about this particular user. In another case, a predefined standing bid may be generated in the exchange service if a network service detects a user visit to either a data seller or a data buyer, and relays the cookie information to the exchange service.

A buyer bid is generally intended to obtain user identifiers, user data, categories of user data, and/or other user data for those users that match the data buyer's predefined choice of categories/subcategories/supercategories of user data. In at least some embodiments, a data buyer may establish a standing bid at a chosen price, and that standing bid may then be automatically entered by the exchange service each time a matching user visits a seller or buyer site. In addition, a data buyer's account may be checked when a bid is entered, to ensure that the data buyer has sufficient funds to participate. A bid may be valid for a predefined window of time, such as a month, a week, a day, an hour, or the like.

The bids may be evaluated to create a market price and scarcity of user data. For example, the exchange service may predefine a top number (n) of buyers that will be allowed to win user data. The highest prices that are bid by the top n buyers may define a range of bid prices that are required for a buyer to win any user data. Thus, the buyer with the nth highest bid may establish a minimum bid price to win user data. Any lower bidders who bid below this minimum bid price may not receive any user data that they bid on. In one embodiment, the top n bidders may be determined for those bids that include at least one category/subcategory/supercategory that is desired by all of the bidders. In at least some embodiments, lower bidders may be excluded based only on price, even if there are no overlapping category among the competing bids.

The minimum price, or price range for the top n bidders may be determined based on a predefined price window of time. For example, only bids that are currently still active, and that have been offered during the last thirty days may be evaluated to determine the minimum price, or price range of the top n bidders. In another embodiment, any bid (even inactive bids) that were offered during the predefined price window may be used to determine the minimum price, or price range that currently active bidders must satisfy to obtain any user data. This creates a market value for the user data based on a scarcity of access to the user data. Minimum price may also be determined through price floors set by the exchange service or by a data seller. For example, a particular data provider may choose not to sell user data below a particular price. A price floor may be set for one or more user segments, one or more categories/subcategories/supercategories, or for any grouping categories/subcategories/supercategories.

In one embodiment, any bidder that satisfies the minimum bid price may obtain user data within the one or more categories that match the bidder-specified categories. In one case, the user data may simply identify each user that matches the bidder-specified categories. The user data may also include user data in other categories that the bidder did not bid on, so that the winning bidder receives additional information about the matching users. In another embodiment, only the bidder with the highest bid price may obtain user data for those users match the winning bidder's specified one or more categories.

In an alternate embodiment, the data buyers may specify that a bid is intended to obtain all user data of a top x number of users that have user data associated with the buyer-specified categories. The top users may be determined as the most recent users to visit a data seller, or other criteria. In another embodiment, a winning bidder may exclude other buyers from obtaining any of the user data for the top x users. This may create another form of a scarcity of user data, which may also affect a market value of that user data. In another embodiment, buyers may obtain user data for exclusive and/or non-exclusive use. The exclusive use of the user data may also be limited to a predefined period, a seller-specified period, a buyer-specified period, an exchange-specified period, or other period.

Similarly, after completing data seller configurations, the exchange service may have already received user data. In addition, or alternatively, the exchange service may receive an ongoing stream of user data, such as user profiles in cookies, from data sellers or from network providers, at an operation 412. This user data may be raw user data, and the exchange service may associate the raw user data with one or more categories. At an operation 414, user data received from data sellers may be matched with one or more categories requested by data buyers and specified in data buyers' campaigns. This matching may be an exact matching, or it may be a less exact association of user data with buyer-specified categories. For example, received user data does not exactly match any buyer-specified category, the exchange service may create a mapping by using synonyms, location information, time information, and/or other contextual data to associate the seller-specified user data with one or more buyer-specified categories.

At an operation 416, the exchange server may determine one or more winning data buyers based on bids received from the data buyers and on the results of the matching operations of operation 414. As part of operation 416, the exchange service may determine those data buyers that are requested one or more categories of the user data. Data buyers may have specified that they wish to bid on user data that is associated with each buyer-specified category. Alternatively, some data buyers may have specified that they wish to bid on user data that is associated with some or all categories, subcategories or supercategories specified for a campaign. The exchange service may filter the data buyers according to their requested categories. The exchange service may also send messages to inform bidding data buyers of other bidders, and allow data buyers to adjust their bids. In one embodiment, this auction process is real-time and continuous as users visit websites of data sellers and/or data buyers. In another embodiment, this auction process may be open for a predefined period, or until another criterion is met.

Based on the data buyers' bids, the exchange service may rank the data buyers. As indicated above, the exchange service may impose a predefined limit (n) on the number of buyers with the highest bids, to set the minimum price required to win any user data. Thus, at least the top n data buyers with the highest bids may win the user data for one or more individual users or one or more user segments that have user data associated with one or more categories requested by a winning buyer. If additional data buyers also made bids at the minimum price, the additional data buyers may also win user data. An example table of tagged users is shown below.

| | SUV | Hawaii Vacation | Dry Cleaning | Winning |
|---|---|---|---|---|
| | Consumer | Consumer | Consumer | Bidder |
| User A | X | X | | Second |
| | | | | Buyer |
| User B | X | X | | Second |
| | | | | Buyer |
| User C | X | | | First Buyer |
| User D | X | | | First Buyer |
| User E | X | | | First Buyer |
| User F | | X | | Second |
| | | | | Buyer |
| User G | | | X | No Buyer |

In this example, Users A and B have user profile data (e.g., cookies or database records with a user identifier and user data that indicates each user's interests or behavior) that includes both an “SUV Consumer” tag and a “Hawaii Vacation Consumer” tag. These users may have browsed information about new SUVs on an automobile dealer website. The owner of the automobile dealer website submitted that user data to the exchange service. Users A and B may have also both booked a vacation flight to Hawaii through a travel website. The owner of the travel website submitted that user data to the exchange service.

A first buyer may have bid 1 cent for each user that has user data in a “SUV Consumer” category and bid 1 cent for each user that has user data in a “Hawaii Vacation Consumer” category. For example, the first buyer may have requested both categories, but requires only that at least one of the categories match a user, not require users to match both categories. In this embodiment, the bid of 1 cent is for user data of a user, regardless of the number of buyer-specified categories that are associated with the user data. Accordingly, in this embodiment, the first buyer's bid for User A would be 1 cent, even though User A is associated with two categories specified by the first buyer.

A second buyer may have bid 3 cent for each user that has user data in a “SUV Consumer” category. Thus, the second buyer's bid for User A would be 3 cents. Because the second buyer's bid is higher, the exchange service may determine that the second buyer wins that individual user. If the exchange service predefined the top 2 buyers to determine the minimum bid price, and no other buyer bid more than 1 cent, then the first buyer may also win the user identifier and other user data associated with User A.

This process continues continuously for each bidder on each user that visits a website of a data seller or each data bidder (or throughout a predefined bidding period). In one embodiment, the highest bidder may retain access to user data for one or more matching users, for as long as no other buyer bids a higher amount for one of the categories associated with those users' data. In another embodiment, the winning bidder may retain the user data for a predefined exclusive-use period, before bidding is opened again to other buyers. In one embodiment, each buyer may be informed of the percent of the price window time that their bid price allowed them to win a user's data. If that percent is less than a 100%, that buyer may be urged to bid higher in order to win a higher percent of the target users. In one embodiment, the winning buyer may be charged the highest bid amount. In another embodiment, the winning buyer may be charged the amount that corresponds to the second-highest bidder.

As indicated above, the top n bidders may be limited, such that lower bidders do not receive any user data. For example, a third bidder may have bid ½ cent for users with user data in the “SUV Consumer” category. However, if the number “n” is set to “2,” the third bidder would receive no user data, because the bid is lower than the top 2 buyers.

In at least some embodiments, different bidding data buyers may have access to differing amounts of user data. The amount available to each bidder may depend at least in part on their bid. This may allow a deeper range (or greater number) of bidders to participate at least in part, and mirrors the behavior in search auctions. For example, each successively ranked bidder may be eligible to receive less user data than the previous bidder (e.g., the top bidder may have access to more user data than the second highest bidder, who has access to more user data than the third highest bidder, and so forth). The amount of user data available to each bidder may be determined using various mathematical formulae. For example, the amount of user data available to each bidder may be determined through a geometric decay calculation, such that the amount of user data available is reduced by a certain percentage for each successive bidder (e.g., if the decay percentage is 10%, the top bidder may be able to buy 100% of the user data, the second highest bidder 10% less −90%, the third highest bidder 81%, the fourth highest bidder 72.9%, and so forth).

In another embodiment, the exchange service may limit the number of times that user data for an identified user or user segment is sold to a particular bidder, or any bidder. For example, a bidder might be limited to ten wins of user data associated with a particular user or user segment. Websites often churn cookies, so a bidder may continue to win a user or user segment, unless the limit prevents additional wins. This may benefit other bidders and may also benefit certain users, who may otherwise receive the same advertisements or other information more often than they might prefer.

Though not depicted in FIG. 4, at operation 416 (or as part of a separate process) the exchange service may also cause the winning bidder to be charged for, and to receive the user data for each user for which they have won the bid. The exchange service may deliver the user data, may instruct the data seller to deliver the user data, may instruct the network provider to deliver the user data, or otherwise cause the user data to be delivered. Similarly, the accounting may be done by the exchange service, or another service.

The exchange may also cause updated user data to be delivered to the winning bidder for those users that have been won. The exchange may further allow the winning bidder to have access to the user data for a predefined period of usage time. After the predefined usage period expires, a second highest bidder, or additional bidders may be allowed access to the user data. Thus, the winning bidder may have exclusive access to the freshest user data for the predefined period. Subsequently, the winning bidder may have to re-bid for another period of access to the user data. That previously winning bidder may have to alter its bids to compete against other bids.

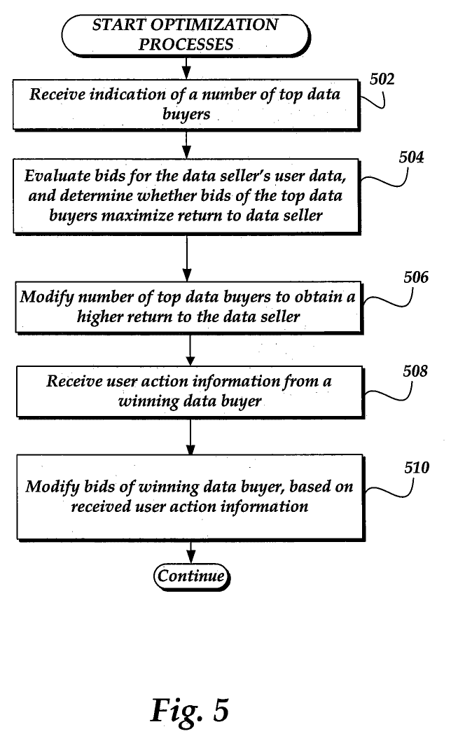

FIG. 5 illustrates a flow chart of an example embodiment of optimization steps for an exchange service. The exchange service may be configured to optimize a data seller's yield/return/profit, a data buyer's return on investment, or other aspects. In this example embodiment at an operation 502, the exchange service receives an indication of a specified number of top “n” bidders, which may be used establish a minimum bid price. The data seller generally offers to sell user data to as many buyers as are interested in acquiring the data seller's user data. The data seller or the exchange service may estimate a limit “n” by evaluating all of the bids during a price window period to determine steps in bid prices, an average, a mean, a percentage, volume of bids, or other characteristic. The limit “n” may change as the bidding changes.

Further, the data seller or exchange service may estimate a time period for use of the user data by the data buyers that meet the minimum bid price of the top “n” buyers. The data seller or exchange service may know that certain user data changes relatively frequently, and may estimate that the user data will be valuable for a certain period before it is stale. After that freshness time period, the exchange service may allow other buyers, other than the minimum bid price buyers, to access the data.

At an operation 504, the exchange service may evaluate bids for the data seller's user data, and may determine whether the bids from the estimated top “n” data buyers produce the highest possible (e.g. maximum) or otherwise optimal return to the data seller. Based on this determination, the exchange service may at operation 506 determine that it would be beneficial to increase or otherwise modify the number of top “n” buyers to obtain a higher total return for the data seller.

Further, the exchange service may determine that the estimated time period of use by a winning bidder may be shortened, because other bidders frequently increase their bids. Alternatively, the exchange service may determine that the estimated time period of use by the top n winning bidders may be lengthened, because bidders return to bid on the seller's user data at certain times of the month. Those skilled in the art will recognize that other variations are possible.

After a winning bidder receives user information for a number of users, the winning bidder may provide advertisements, messages, or other information to those users based on the user information received. The winning bidder, the exchange service, an advertising service, a content website, or another service may track responses from those users. For example, the winning bidder may record which of the users perform a particular action, such as selecting a banner advertisement, purchasing an advertised product, or performing other actions. At an operation 508, the winning bidder may provide the tracked action information to the exchange service (or vise versa, etc.). At an operation 510, the exchange service may modify bid amounts, bid-upon categories, or other parameters based on the received action information. For example, the exchange service may modify a data buyers bid amount for those categories that correspond to users that more frequently click on the data buyer's advertisements, purchase the data buyer's products, or otherwise perform the data buyer's desired action.

Further, the exchange service may evaluate the performance of conventional pay-per-click services. The exchange service may track the number of actual clicks (or other desired action) that users perform for the data buyer's advertisements or other campaign aspects. The exchange service may determine the average payment made for those users that performed the click or other desired action, relative to those users that did not perform the click or other desired action. The exchange service may provide that information to the data buyer for use in selecting a bid amount to win future users.

In another embodiment, an exchange process can be listed with the following example steps relative to some of the terms defined above:
1. System uploads BidTable (TaxonomyIDs, MaxBids and CampaignIDs, campaign definition) to exchange service servers. The exchange service server may be a pixel server. TaxonomyID may also be referred to as TaxID.
2. User hits one of the universal script tags on the Buyer or Seller site. The universal script tags may be pixel tags.
3. The exchange service reads the user's cookie.
4. If the time stamp on any previously recorded (in the cookie) PreviousWinningBid is outside the MaxAllowedTimeWindow, then system erases that PreviousWinningBid from the cookie.
5. The exchange service looks at the TaxonomyIDs previously recorded in the cookie and eliminates all bids from the BidTable that don't correspond to the CampaignIDs from consideration.
6. The exchange service picks the MaxNewWinners highest remaining bids from the BidTable. These bids are PotentialWinners.
7. CountPotentialWinners is less than or equal to AvailableWinnerSlots (=TotalWinnerSlots−CountPreviousWinningBids) then all PotentialWinners become NewWinningBids.
8. If there are no AvailableWinnerSlots, then the PotentialWinners with MaxBids higher than the any of the lowest value PreviousWinningBids become NewWinningBids.
9. If the number of PotentialWinners is more than AvailableWinnerSlots but less than CountPotentialWinners, then system picks PotentialWinners to become NewWinningBids in such a way as to maximize CountNewWinningBids.
10. System price reduces NewWinningBids to 10% over next highest bid from the BidTable.
11. System records NewWinningBids in the cookie as PreviousWinningBid.

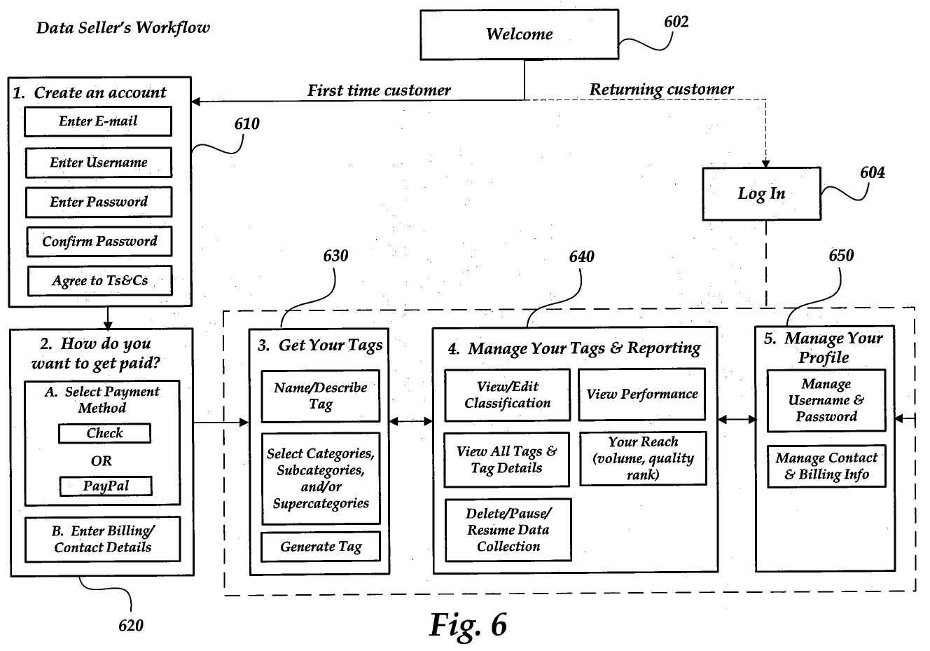

FIG. 6 illustrates, for an embodiment, a workflow for a data seller to provide profile data to the exchange service, and manage a data seller account. Through interaction with the exchange service, the data seller may generally specify user data to be provided, classify the user data into one or more categories/subcategories/supercategories, and manage sales performance based on the provided user data, as well as perform other tasks related to the service. For a seller to participate in the exchange service they may enter the exchange service through a Welcome screen/portal/window 602. If the data seller is a first time visitor to the exchange server, the data seller may create an account at workflow step 610. Creating an account may include creating a login (e.g., a usemame and password), entering a preferred e-mail address to receive communications from the exchange service, confirming the password, agreeing to Terms & Conditions for use of the exchange service, or other tasks.

After creating an account, the data seller may specify how it wants to get paid, at a workflow step 620. This may include selection of a payment method (e.g., by check, PayPal, or through some other payment system). Workflow step 620 may also allow the data seller to enter billing or contact details of the data seller. Billing details may include a billing address, preferred day of the month for billing, preferred means of receiving the bill, or other such details. Contact details may include contact address/phone/e-mail for the data seller, as well as identification of a contact individual, along with other such details. In some embodiments, account set-up may include the set up of additional HINTS and ATTRIBUTE parameters, or connection through an exchange service API for offline data passing.

Once the first time data seller has created an account and specified payment details in workflow operations 610 and 620, the data seller may then be granted access to additional functionality of the exchange service. For example, in workflow operation 630, the data seller may describe raw user data that it wishes to provide for sale via the exchange service, from one or more websites, and get script tags to place on those websites to facilitate the collection of user data. The data seller may select one or more categories, subcategories, and/or subcategories for the raw user data that will be collected from the data seller's website. As discussed herein, in some embodiments the exchange service itself may determine one or more categories, subcategories, and/or supercategories for the raw user data. At workflow operation 630, the data seller may also generate a universal script tag to be placed within the data seller's website. As discussed herein, the script tag may function to write a cookie onto a user device when the user visits the data seller's website. This cookie may contain information related to the user's visit, identification data for the user, user data or other information. The script may be written in JavaScript or other scripting language. The script tag may be placed into the header or footer of the data seller's website.

At a workflow operation 640, the data seller may have access to functionality for managing the data seller's user data to be provided and reporting. This functionality may include viewing, editing, confirming, or updating the exchange service's classification of a data seller's URL. The data seller may also have access to a summary of all user data information the data seller has entered, along with details such as a friendly name, description, category, subcategory, supercategory or other attribute of raw user data to be provided. The data seller may also view performance such as bids entered for the user data, average bid, the revenue generated from the user data, and similar performance-related statistics. The data seller may also view the reach of its user data, including a volume or quality rank. Also at workflow operation 640, the data seller may delete, pause, or resume data collection. At a workflow operation 650, the data seller may manage its profile. This may include such functionality as managing a username or password, or managing contact information or billing information.

Those data sellers who have already gone through operations 610 and 620 are returning data sellers, and may log in to the exchange service using their existing login/password at a login operation 604. Such data sellers may then access the functionality of workflow operations 630, 640 and 650.

In at least some embodiments, to technically integrate with the exchange service, the data seller may use a universal pixel, which enables a smart cookie, to allow interoperability of data. This universal pixel helps to (1) maximize ease of technical implementation for seller, and (2) ensure high quality categorization/classification of seller data into a buyer-facing taxonomy, and (3) minimize processing at a pixel server level.

In one embodiment, there are 3 types of data that the exchange service recognizes (taxonomies, hints, and attribute value lists). These are captured as two structured parameters (Taxonomy_id and ATTRIBUTES) and one open parameter (HINTS). The taxonomy_id may serve as an identifier of a category, subcategory or supercategory, and a set of categories/subcategories/supercategories supported by the exchange service may generally be considered a taxonomy of categories, subcategories, and/or supercategories. The taxonomy_id is passed into the pixel system by the data seller in order to classify the user (or user's page or user data generally) in the exchange service's global taxonomy of categories. More than one taxonomy_id may be submitted in a single transaction. The HINTS parameter allows for attributes (e.g. keywords) that the data seller has not yet mapped to the exchange service's taxonomy of categories. This information may be used by the exchange service to create mappings from a data seller's taxonomy into the exchange service's taxonomy. The ATTRIBUTES variable allows data sellers to return ranges, lists or single variables that add more information for the user. The attribute value lists are usually used in the context of a user rather than the context of the page. An example of user data may:

$$\{ \begin{matrix}Sellerid = Next Action \\ Siteid = Orvis . com \\ Sectionid = ( optional ) \\ Taxonomy\_id = Retail \\ seller\_userid ( optional , only if using Server to Server API and \\ need look up id ) = 1234 \\ user\_id = 12345 \\ HINTS = Fishing Equipment , poles , lake fishing \\ ATTRIBUTES ( optional ) =\end{matrix}$$

The HINTS parameter may allow data sellers pass one or more keywords to facilitate classification of the page and/or the collected raw user data into one or more categories. ATTRIBUTES may include (1) additional user attributes/information that is passed in real-time or (2) offline user attributes/information passed, for example, through a nightly synchronization process. A Server to Server API may be used to transfer data.

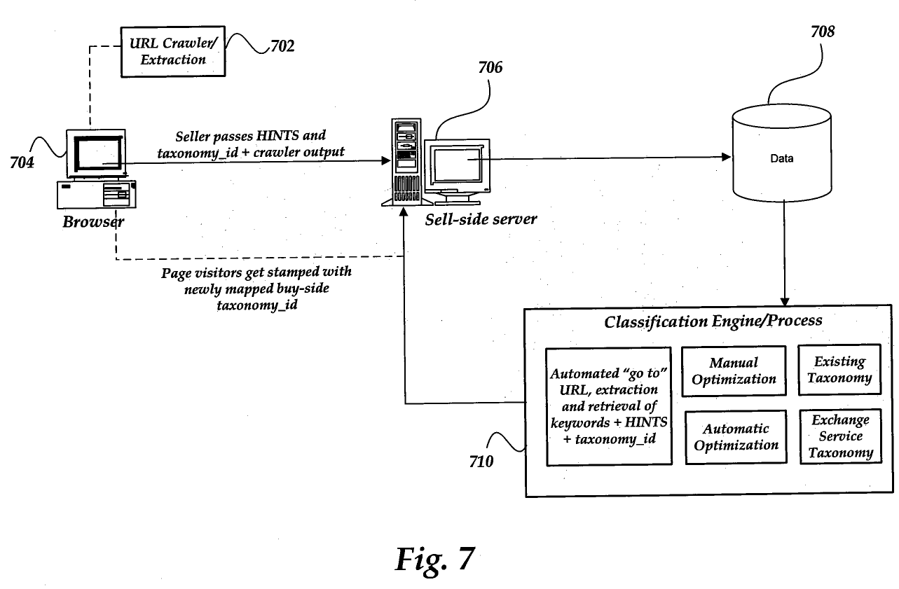

FIG. 7 depicts an example taxonomy mapping workflow to classify a data seller's website into the exchange service's taxonomy of categories/subcategories/supercategories. Data sellers may access a sell-side exchange service pixel server 706 via browser 704 or other means, to pass HINTS, taxonomy_id, and/or crawler output to a sell-side server 706. The taxonomy_id parameter may be used by data sellers to pass a taxonomy_id for that webpage visited by the user. It may be as specific as “Women's shoes” or as broad as “Retail”. Further classification of the data seller's webpages to the exchange service's taxonomy may occur as part of a set-up process. When the pixel tags are implemented, the exchange service may collect all the passed “Taxonomy_ids” and “HINTS” in a data store 708. In addition, the exchange service may crawl and extract relevant information from the data seller's URL through operation of a URL Crawler/Extraction process 702. The exchange service may classify the data seller's pages with an exchange service classification engine or process 710. The classification process may be automatic or manual, and may map the data-seller passed parameters to the exchange service taxonomy. This new classification/mapping may be pushed out to an exchange service pixel server 706 so that users (e.g. visiting users) are then stamped with the appropriate/updated taxonomy_id—without requiring page-by-page scripting of the sellers pages.

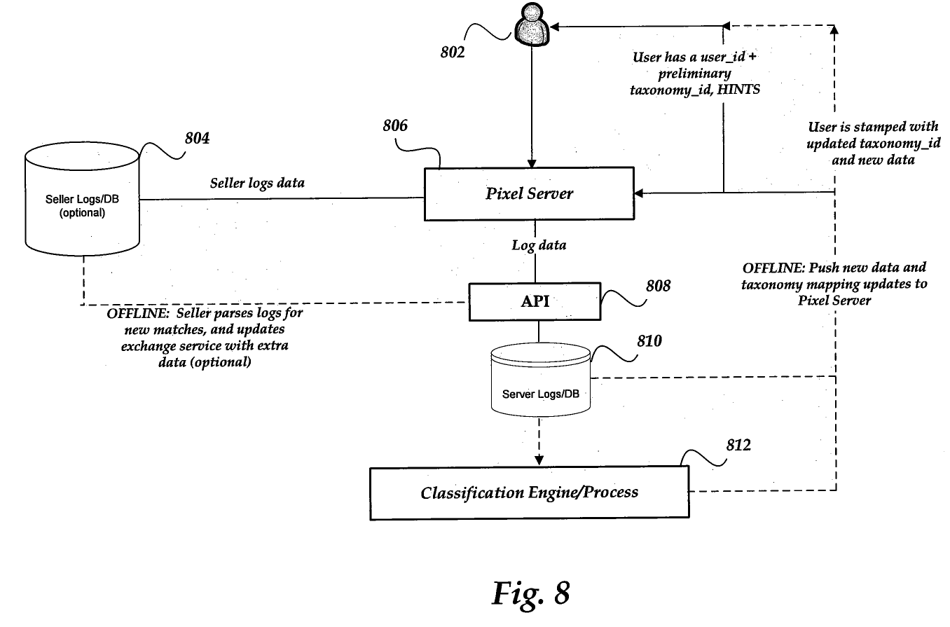

FIG. 8 illustrates another example of a taxonomy mapping workflow. In this example, a pixel tag has been placed in a data seller's website. A user 802 may have already been assigned a user_id by the exchange service, and may also be associated with one or more taxonomy_id values or HINTS. When user 802 visits a data seller's website, the pixel tag may allow exchange service pixel server 806 to gather data regarding the user's visit. This user data may be logged by the exchange service, processed via an API or set of APIs 808, and stored in an exchange service database 810. An exchange service classification engine or process 812 may operate to classify the user data into a taxonomy of one or more categories, subcategories and/or supercategories, and may also update taxonomy mappings and user data. This engine/process may be the same as classification engine/process 710 shown in FIG. 7, or it may be a separate engine/process. Classification engine/process 812 may push new data and taxonomy mapping updates to pixel server 806. This push may be done offline. Classification engine/process 812 may also stamp user 802 with one or more updated taxonomy_id value and/or user data.

A data seller may also contribute data in an offline method. An example of this is illustrated in the left portion of FIG. 8. In this example, a data seller may gather user data from pixel server 806 and save data to a database 804. Data sellers can then communicate to the exchange service through an API 808 to deliver user data or other information. The transport protocol of the API may be FTP using POST. The syntax may be XML.

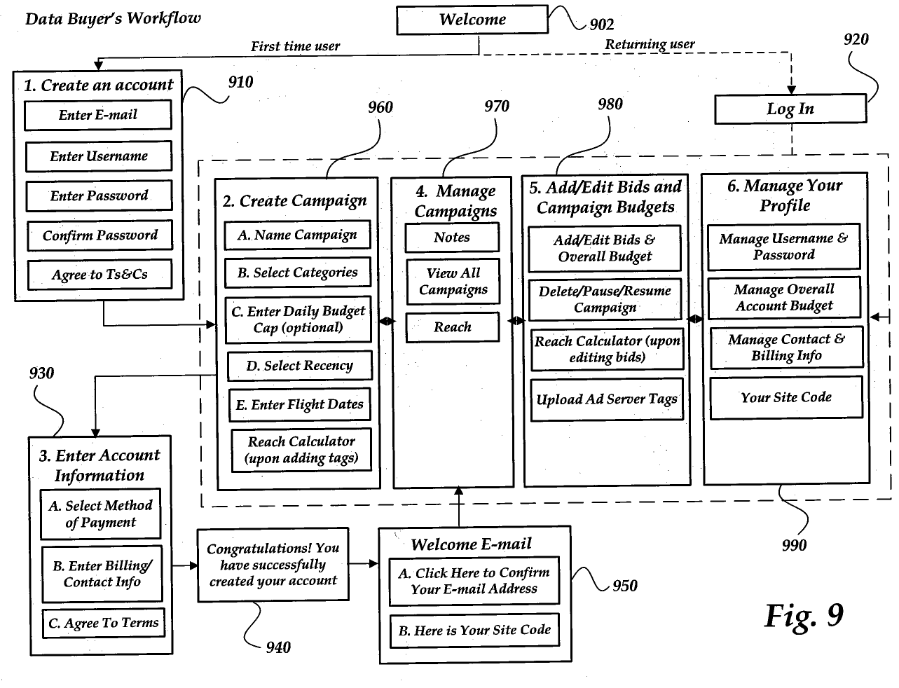

A data buyer can create a campaign as discussed above. An embodiment of a data buyer's workflow is illustrated in FIG. 9. After passing through a Welcome page/screen/window 902, a data buyer who is a returning user of the exchange service may log in via a username and password previously created. Such a returning user may have access to data buyer workflow functionality including functionality to create campaigns 960, manage campaigns 970, add/edit bids and campaign budgets 980, or managing profiles 990, all of which are discussed in more detail herein. Alternatively, a data buyer who is a first-time user of the exchange service may be directed to create an account in workflow operation 910. Creating an account may include entering an e-mail address for future communications, entering a username and password for login identification, confirming the password, and agreeing to exchange service Terms and Conditions (“Ts & Cs”).

A data buyer may then log in to the exchange service to create a campaign, as shown by workflow operation 960. Creating a campaign may include providing a name for the campaign, selecting one or more categories/subcategories/supercategories to be included in the campaign, and selecting a recency and/or flight dates for a campaign. The data buyer may also enter a daily budget cap. After one or more categories for the campaign have been added, a reach calculator may be made available to the data buyer. The reach calculator may allow the data buyer to see how increasing or decreasing bids or daily budget cap might affect the reach of their campaign, or other campaign aspects. The reach calculator may also include functionality to allow the data buyer to change bids or daily budget cap.

Upon creating a campaign, the data buyer may enter account information at a workflow operation 930. Account information may include selecting a method of payment (e.g., cash, check, PayPal, credit card, bank transfer, or other methods); entering billing information or account information, such as identification information (e.g., name, address, phone number, contact individual name) or information related to timing of bills (e.g., frequency or scheduling of billing); and agreement to Terms and Conditions. Upon creating an account, the data buyer may be shown a confirmation 940, confirming that the data buyer has successfully created an account. This confirmation may be displayed in a web page, pop-up window, or through other means. The exchange service may also send a welcome/confirmation/activation e-mail 950 to the data buyer. This e-mail may include a link or other dynamic content to allow the recipient to confirm that the e-mail address is correct, valid, or active. The email may also include a site code for use by the data buyer. The data buyer may also be required to click the link in order to activate the account. In some embodiments, the data buyer may be required to enter account information 930 after creating an account in workflow operation 910.

After receiving the welcome e-mail 950, the data buyer may have access to functionality to allow the data buyer to manage one or more campaigns, at workflow operation 970. Managing campaigns may include adding/editing/deleting notes on the campaign, and viewing all campaigns and campaign details such as friendly name, category/sub-category, and attributes. Managing campaigns may also include viewing information related to the reach of campaigns, such as the user data won, the percentage of user data bid on that was won, and one or more quality parameters associated with the user data or with the campaign.

At workflow operation 980, a data buyer may add and edit bids and budgets for campaigns. This may include managing maximum bids or average bids, and managing budget caps for campaigns. Through editing bids, the data buyer may have access to the reach calculator as in operation 960, to allow the data buyer to see how increasing or decreasing their bids or daily budget cap could affect their campaign. The data buyer may also delete, pause or resume campaigns, and in general set campaign status tags. At workflow operation 980, the data buyer may also be able to upload ad server tags (e.g. pixel tags).

The data buyer may also tie the campaign to an order as part of interface 980, or in other parts of the workflow, such as through the Create campaign web page interface 960. The order may be tied to a budget that can be managed in Manage Your Profile operation 990. An order may allow data buyers to tie multiple campaigns to one budget and manage multiple orders or budgets through the same log-in. To create a new order, a data buyer may have access to a “Create New Order” link on Create Campaign workflow operation 960, Manage Your Profile operation 990, or elsewhere in the data buyer workflow. At a workflow operation 990, a data buyer may manage its profile or its account information. This may include managing username and password, managing overall account budget, managing contact and billing information, and managing the data buyer's site code.

Data buyers may also technically integrate with the exchange service. In one embodiment, an integration method for a data buyer may be:
1. A data buyer is e-mailed a piece of javascript during the sign-up process to place on their pages
2. The data buyer places a piece of JavaScript within a global header/footer on their entire site.

An alternate integration method (e.g., for data buyers such as Ad Networks) is for a data buyer to upload their ad server tags (e.g. pixel tags) directly into the exchange service system by:
1. Going to an Account Management portion of the user interface, such as workflow operation 980
2. Selecting the campaigns they want to edit
3. Hit “Add/Edit Campaign Pixels”
4. An “Add/Edit Campaign Pixels” interface appears
5. Buyers can “Add” pixels to campaigns or “Edit” existing pixels

In one embodiment, a data provider API may provide an online mechanism that partners use to provide user data to an exchange service. For example, the API may be a modified REST API. Generally, this API will not be called directly, but instead through a page tag.

Method:
http://tags.bluekai.com/site/[ID]
   The id above is an example of a site id issued in the data buyer interface.

Arguments:

The following optional arguments may be supported in one embodiment:

| Param | Description |
|---|---|
| ret | Determines the type of return value. The options are: |
| | 1. “pixel” - requests a 1 × 1 pixel (which can also award the data to |
| | one auction winner). |
| | 2. “js” - requests javascript snippet (which can award the data to |
| | several auction winner). |
| | If not specified, a pixel return is assumed. |
| url | Allows the caller to specify the url of the page triggering the API, when it |
| | is not otherwise available (for example, when the API is called within |
| | another partner's tags). |
| rurl | Allows the caller to specify the referring url of the page triggering the API, |
| | when it is not otherwise available (for example, when the API is called |
| | within another partner's tags). |
| phint | Allows the caller to provide key-value pairs to provide context about the page. |
| | These key value pairs should be URL encoded. |
| uhint | Allows the caller to provide key-value pairs to provide context about the |
| | user. These key value pairs should be URL encoded. |

### HTTP Status Codes:

The following return codes may be returned by the Provider API in this embodiment:

| Code | Description |
|---|---|
| 200 | Success. |
| 304 | Success. An auction has been performed, redirecting to a winner. |
| | Only occurs when a pixel return type is requested. |
| 400 | Error. The API call was incorrectly formed. |
| 401 | Error. This is an error return code indicating that the Provider API |
| | has been from domain not permitted by the partner. |

Examples of user data that may be provided to the exchange service by a data seller/data provider:

### EXAMPLE 1

http://tags.bluekai.com/site/982310
The tag in example 1 is an example of a simple possible case. In example 1, a provider is notifying the exchange service that a user has visited its site, 982310, and is requesting a pixel return type.

### EXAMPLE 2

http://tags.bluekai.com/site/982310?r=js&uhint=“G=M”&uhint=“Z=98005”
   In the above tag for example 2, a provider is notifying the exchange service that a user has visited the providers site, 982310. Also the provider is handing the exchange service a pair of facts about the user: G=M and Z=98005. The provider wants a javascript return type.

### EXAMPLE 3

http://tags.bluekai.com/site/982310?url=“http://www.llbean.com/shoes”
&uhint=“na_id=LDJFLSJFAHFDO1012823”

In the above tag for example 3, a partner is notifying the exchange service that a user has visited a site, 982310. The partner is passing the exchange service a pair of facts: url—the page context of the tag, and a fact about the user “na_id” that can be later used to merge offline data between the exchange service and the partner. The partner is asking for a pixel return.

In at least some embodiments, one or more user segments may be defined. A user segment may be a grouping or collection of one or more categories or sub-categories. A data seller, data buyer, customer of a data buyer, or other user of the exchange, or the exchange itself, may define a segment by indicating a combination of categories, subcategories and/or supercategories with one or more boolean operations such as AND, OR, XOR and NOT. For example, a particular segment encompassing purchasers of SUVs in the east coast states of the United States may be defined as “SUV purchasers” AND “residents of east coast states.” A segment may include categories/subcategories/supercategories which include user data of the same type or of different types. Generally, user data from one or more segments may be selected or otherwise requested by a data buyer who bids on user data.

In at least some embodiments, a party defining a segment (e.g., a customer of a data buyer) may define a segment to include one or more categories of data that are selling well (or for which demand is high), together with one or more categories of data that are not selling well (or for which demand is not as high). In this way, the party defining a segment may seek to include slower moving (e.g. relatively lower demand) data along with faster moving (e.g., relatively higher demand) data as a way of upselling the slower moving data.

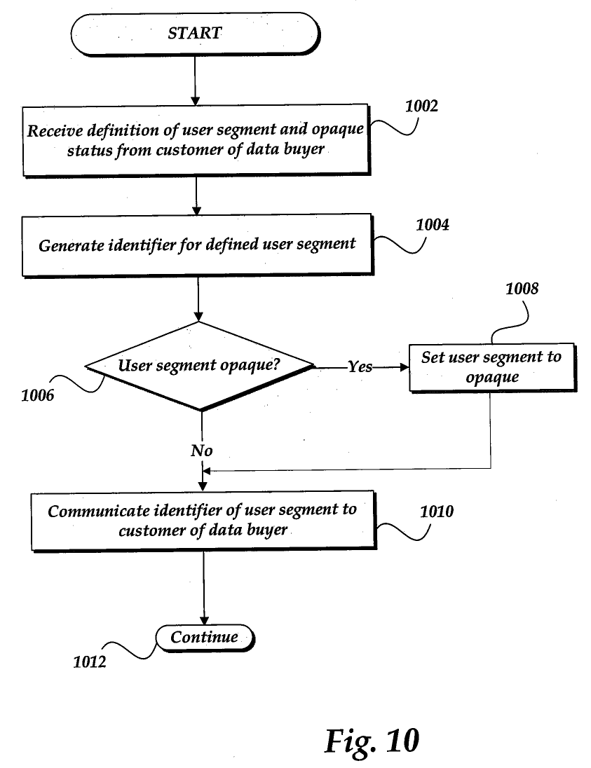

FIG. 10 illustrates an example embodiment of a process for defining a user segment for the exchange service. After the start of the process, the exchange service may receive a definition of a user segment at operation 1002. In some embodiments, such definition of a user segment may be received from a customer of a data buyer, but in other embodiments the definition may be received from a data buyer, a data seller, or generally any other user of the exchange service. The definition may be in the form of a grouping or a collection of one or more categories, subcategories and/or supercategories of user data joined together through Boolean operations such as AND, OR, XOR, NOT or other operations. The definition may include positive combinations of categories (e.g., Category A AND Category B AND Category C), and may also include negative exceptions via a NOT operation (e.g., Category A OR Category B AND NOT Subcategory D).

Further at operation 1002, a customer of a data buyer may also indicate whether the segment is to be opaque—that is, whether the definition of the segment is visible to or otherwise ascertainable by parties or entities other than the defining customer of a data buyer. For example, if the status of a segment is opaque, the definition of the segment will not generally be visible to parties other than the data buyer who defined the segment. If a segment is opaque, it may be identified by a particular segment ID number or some other identifier. In at least some embodiments, if a segment is not opaque, it may be additionally associated with a segment name that may be in some way descriptive of the segment (e.g. “east coast SUV purchasers”). In at least some embodiments, opaque status for a segment may default to either opaque or not opaque, and this default opaque status may be applied to a segment even if the customer of the data buyer did not specify an opaque status. Also, the opaque status may be defined by the user on an individual basis so that the opacity is particular to the particular party that attempts to view the details of a particular segment identified by a particular segment ID.

At operation 1004, an identifier may be generated for the defined user segment. The identifier may be a number, character string, hashed value, or some other identifier, and may be unique for each defined segment. Generally, the identifier will be generated by the exchange service and associated with the segment, but in some embodiments a user who defines a segment may request a particular identifier. In at least some embodiments, if a segment is opaque it may also be advantageous to identify a segment by a different identifier to each data buyer interested in requesting data associated with the segment. These different identifiers may then be internally associated (within the exchange service) to a global or true segment identifier.

At decision operation 1006, it may be determined whether the segment is to be opaque, based on the opaque status received at operation 1002. If the segment is requested to be opaque, the exchange service may set the segment to opaque at operation 1008, after which the process may proceed to operation 1010. If the segment is requested to be not opaque at decision operation 1006, the process may proceed to operation 1010.

At operation 1010, the exchange service may communicate the identifier of the segment to the customer of the data buyer, or other party from whom the definition of the user segment was received at operation 1002. This communication may be via email, other electronic message, or other communications method, or the identifier may be displayed to the customer of the defining party as part of an exchange service user interface such as data exchange interface 246, or as part of the creating or managing campaigns sections of the workflow process of FIG. 9. The process may then continue at operation 1012.

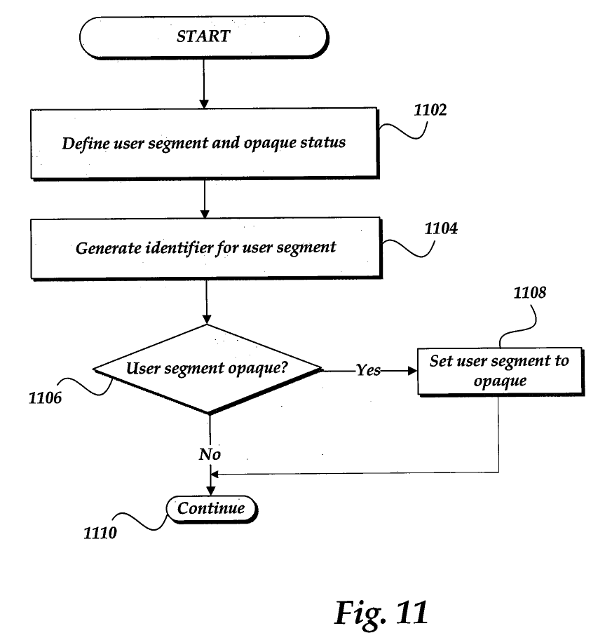

FIG. 11 also illustrates an example embodiment of a process for defining a user segment for the exchange service. In at least some embodiments, after the start of the process the exchange service itself may define of a user segment and its opaque status at operation 1102. The definition may be in the form of a grouping or a collection of one or more categories or sub-categories of tags joined together through Boolean operations such as AND, OR, XOR, NOT or other operations. The definition may include positive combinations of categories or subcategories (e.g., Category A AND Category B AND Category C), and may also include negative exceptions via a NOT operation (e.g., Category A OR Category B AND NOT Subcategory D). Also, the opaque status may be defined by the user on an individual basis so that the opacity is particular to the particular party that attempts to view the details of a particular segment identified by a particular segment ID.

At operation 1104, an identifier may be generated for the defined user segment. The identifier may be a number, character string, hashed value or some other identifier, and may be unique for each defined segment. Generally, the identifier will be generated by the exchange service and associated with the segment, but in some embodiments a user who defines a segment may request a particular identifier. In at least some embodiments, if a segment is opaque it may also be advantageous to identify a segment by a different identifier to each data buyer interested in requesting data associated with the segment. These different identifiers may then be internally associated (within the exchange service) to a global or true segment identifier.

At decision operation 1106, it may be determined whether the segment is to be opaque, based on the opaque status received at operation 1102. If the segment is requested to be opaque, the exchange service may set the segment to opaque at operation 1108, after which the process may continue at operation 1110. If the segment is requested to be not opaque at decision operation 1106, the process may continue at operation 1110.

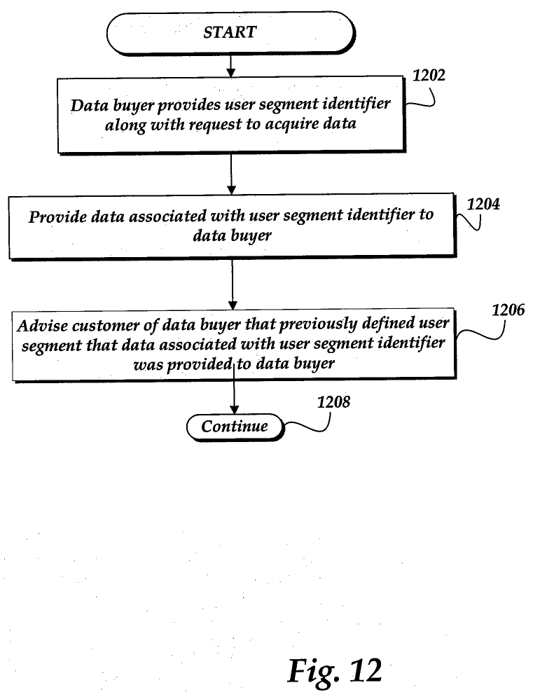

FIG. 12 illustrates an example embodiment of a user segment certification process for an exchange service. After the process starts, at operation 1202 a data buyer may provide a user segment identifier along with a request to acquire data associated with the segment. The data buyer may provide this request, for example, through an exchange service user interface such as data exchange interface 246, or as part of the creating or managing campaigns sections 960 and 970, or other aspects of the data buyer workflow process of FIG. 9.

At operation 1204, the exchange service may then provide data associated with the user segment identifier provided at operation 1202, to the requesting data buyer. At operation 1206, the exchange service may then communicate to a party or entity who previously defined the segment (e.g., the customer of a data buyer who defined the segment in operation 1002 of FIG. 10) that data associated with the segment identifier was provided to the data buyer. The process may then continue at operation 1208.

In at least some embodiments, the exchange service may also collect and report consumption data for users in a data segment (e.g., data regarding sales of products and/or services made to users, or generally the activities and behaviors of those users). This consumption data may be provided as a service to the party who defined the user segment (e.g., the customer of the data buyer as discussed with regard to FIG. 10). The consumption data may be useful to the party who defined the user segment, who may wish to model or otherwise analyze the data and subsequently monetize their models or analysis.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent is:

1. A method for exchanging data, comprising:
receiving from one or more data sellers an indication of user data to be sold;
receiving from one or more data buyers campaign information including one or more requested categories of user data;
receiving bids from the one or more data buyers;
receiving from the one or more data sellers user data associated with the indication of user data to be sold;
matching the received user data with the requested categories from the campaign information; and
determining one or more winning data buyers based on the received bids and the matched user data.

2. The method of claim 1, wherein determining the one or more winning data buyers further includes:
receiving an indication of a number of top data buyers;
determining whether the bids received from the top data buyers maximize a return; and
modifying the number of top data buyers to obtain a higher return.

3. The method of claim 1, further comprising:
receiving user action information from at least one winning data buyer; and
modifying at least one bid based on the received user action information.

4. The method of claim 1, further comprising receiving from at least one data seller an indication of one or more disallowed data buyers that should not receive user data from the at least one data seller.

5. The method of claim 1, further comprising:
charging at least one winning data buyer; and
sending the received user data to the at least one winning data buyer.

6. The method of claim 1, further comprising:
charging at least one winning data buyer; and
allowing the at least one winning data buyer access to the received user data for a period of time.

7. The method of claim 1, wherein determining the one or more winning data buyers further includes:
determining a lowest bid from the bids of a number of top data buyers; and
identifying the one or more winning data buyers as those data buyers whose bid is at least the lowest bid.

8. The method of claim 1, further comprising:
allowing at least one winning data buyer access to the retrieved user data for a period of time; and
modifying the period of time to obtain a higher return.

9. The method of claim 1, further comprising providing to the one or more data sellers a script tag, and wherein the received user data further includes data stored by a cookie placed on a user device by the script tag.

10. The method of claim 1, further comprising receiving a maximum bid from at least one data buyer, wherein determining the one or more winning data buyers is further based on the received maximum bid.

11. The method of claim 1, further comprising:
receiving from at least one customer of at least one of the data buyers at least one definition of a user segment and an opaque status;
generating an identifier for the defined user segment;
setting an opacity of the defined user segment, based on the received opaque status; and
communicating the identifier of the user segment to the at least one customer of the at least one of the data buyers.

12. The method of claim 1, further comprising:
defining at least one user segment, and an opaque status for the at least one user segment;
generating an identifier for the at least one user segment; and
setting an opacity of the at least one user segment, based on the opaque status.

13. The method of claim 1, further comprising:
receiving from at least one customer of at least one of the data buyers at least one definition of a user segment and an opaque status;
generating an identifier for the defined user segment;
setting an opacity of the defined user segment, based on the received opaque status;
communicating the identifier of the user segment to the at least one customer of the at least one data buyer;
receiving from the at least one data buyer the user segment identifier with a request to acquire data;
providing data associated with the user segment identifier to the at least one data buyer; and
advising the at least one customer of the at least one data buyer that data associated with the user segment identifier was provided to the at least one data buyer.

14. A system for exchanging data, comprising:
a plurality of client devices;
a plurality of data seller devices, in communication with the plurality of client devices;
a plurality of data buyer devices; and
an exchange server device in communication with the plurality of data seller devices and the plurality of data buyer devices, operative to perform actions including:
receiving from at least one of the data seller devices an indication of user data to be sold;
receiving from at least one of the data buyer devices campaign information including one or more requested categories of user data;
receiving bids from the at least one of the data buyer devices;
receiving from the at least one of the data seller devices user data from at least one of the client devices, wherein the user data is associated with the indication of user data to be sold;
matching the received user data with the requested categories from the campaign information; and
determining one or more winning data buyers based on the received bids and the matched user data.

15. The system of claim 14, wherein the exchange server device is further operative for providing to the plurality of data seller devices a script tag, and wherein the received user data further includes data stored by a cookie placed on at least one of the client devices by the script tag.

16. The system of claim 14, wherein determining the one or more winning data buyers further includes:
receiving an indication of a number of top data buyers;
determining whether the bids received from the top data buyers maximize a return; and
modifying the number of top data buyers to obtain a higher return.

17. The system of claim 14, wherein the exchange server device is further operative for:
receiving user action information from at least one winning data buyer; and
modifying at least one bid based on the received user action information.

18. A processor-readable storage medium storing instructions which when executed on a processor enable actions for exchanging data, comprising:
receiving from one or more data sellers an indication of user data to be sold;
receiving from one or more data buyers campaign information including one or more requested categories of user data;
receiving bids from the one or more data buyers;
receiving from the one or more data sellers user data associated with the indication of user data to be sold;
matching the received user data with the requested categories from the campaign information; and
determining one or more winning data buyers based on the received bids and the matched user data.

19. The processor-readable storage medium of claim 18, wherein determining the one or more winning data buyers further includes:
receiving an indication of a number of top data buyers;
determining whether the bids received from the top data buyers maximize a return; and
modifying the number of top data buyers to obtain a higher return.

20. The processor-readable storage medium of claim 18, wherein the stored instructions further enable actions comprising:
receiving user action information from at least one winning data buyer; and
modifying at least one bid based on the received user action information.

21. A network device for data exchange, comprising:
a processor;
a communication interface in communication with the processor and with a network; and
a memory in communication with the processor, storing instructions which when executed on the processor enable actions including:
receiving from one or more data sellers an indication of user data to be sold;
receiving from one or more data buyers campaign information including one or more requested categories of user data;
receiving bids from the one or more data buyers;
receiving from the one or more data sellers user data associated with the indication of user data to be sold;
matching the received user data with the requested categories from the campaign information; and
determining one or more winning data buyers based on the received bids and the matched user data.

22. The network device of claim 21, wherein the stored instructions further enable actions comprising:
allowing at least one winning data buyer access to the retrieved user data for a period of time; and
modifying the period of time to obtain a higher return.

23. The network device of claim 21, wherein the stored instructions further enable actions comprising receiving a maximum bid from at least one data buyer, and wherein determining the one or more winning data buyers is further based on the received maximum bid.
